(19) United States
(12) Patent Application Publication
(10) Pub. No.: US 2019/0284401 A1
(43) Pub. Date: Sep. 19, 2019

(54) ANTI-BACTERIAL AND ANTI-DUST COATING FOR AIR DUCTING

(71) Applicant: Wo Lee Green Solutions Ltd., Hong Kong (HK)

(72) Inventors: Su Ping BAO, Hong Kong (HK); Man Lung SHAM, Hong Kong (HK); Wen Jun LUO, Hong Kong (HK)

(73) Assignee: Wo Lee Green Solutions Ltd., Hong Kong (HK)

(21) Appl. No.: 16/299,125

(22) Filed: Mar. 11, 2019

Related U.S. Application Data
(60) Provisional application No. 62/643,151, filed on Mar. 14, 2018.

(51) Int. Cl. C09D 5/14; C09D 7/61; C09D 7/40; C09D 7/65; C09D 7/63; C09D 133/04; C08K 3/22

(52) U.S. Cl. CPC C09D 5/14; C09D 7/61; C09D 7/67; C09D 7/69; C09D 7/80; C09D 7/63; C09D 133/04; C08K 3/22; C09D 7/65

(57) ABSTRACT

The present invention relates to an anti-bacterial and anti-dust coating for air ducting. In one embodiment, the anti-bacterial and anti-dust coating comprises: a polymer emulsion; a cross linking agent; a film forming agent; a filler and anti-dust agent; an anti-bacterial agent; hardener nanoparticles; a defoamer; and water. The anti-bacterial agent can be in powder or in liquid form. The coating can be applied on the inner surface of metal air ducting to reduce dust aggregation and prevent growth of bacteria, mold and mildew that causes stains and odors inside air ducting. With the aids of nanotechnology, various specific nanoparticles are added in the waterborne polymer emulsion to provide the anti-bacterial, anti-dust, anti-acid, anti-alkali, good flexibility and hardness for the coating. The product is also tested to be flame retardant and water resistance for increased safety in air ducts.

### CROSS REFERENCE TO RELATED APPLICATIONS

The present application claims priority from U.S. provisional application 62/643,151 filed on 14 Mar. 2018, the entirety of which is incorporated herein by reference.

### FIELD OF INVENTION

The present invention relates to the field of anti-bacterial coatings, in particular to an anti-bacterial and anti-dust coating for air ducting.

### BACKGROUND OF INVENTION

Indoor air quality is a critical issue inside buildings. Growth and spread of bacteria in air ducts of the buildings is a main factor affecting the air quality of the building. Removing dust aggregation inside these air ducts is tedious and costly. Therefore, a solution is needed to solve the problem of dust aggregation inside air ducts especially metal air ducts, prevent the growth of bacterial, improve the indoor air quality and to reduce additional maintenance fee for cleaning.

### SUMMARY OF INVENTION

In light of the foregoing background, an anti-bacterial and anti-dust coating for air ducting is provided. The coating can be applied on the inner surface of metal air ducting to reduce dust aggregation and prevent growth of bacteria, mold and mildew that causes stains and odors inside air ducting. With the aids of nanotechnology, various specific nanoparticles are added in the coating to provide the anti-bacterial, anti-dust, anti-acid, anti-alkali and good flexibility and hardness. Also, the coating has added property of being water resistant and flame retardant to improve the usability and safety of the coated air duct.

In one embodiment, the anti-bacterial and anti-dust coating comprises: 100 parts by weight of a polymer emulsion; 0.1-10 parts by weight of a cross linking agent; 0.1-10 parts by weight of a film forming agent; 0.1-10 parts by weight of a filler and anti-dust agent; 0.1-10 parts by weight of an anti-bacterial agent; 0.1-10 parts by weight of nanoparticles; 0.1-10 parts by weight of a defoamer; and 1-15 parts by weight of water.

In a preferred embodiment using a powder anti-bacterial agent, the coating comprises: 100 parts by weight of emulsion; 1-1.5 parts by weight of cross linking agent; 1-1.5 parts by weight of film forming agent; 1.5-3 parts by weight of anti-dust agent; 1.5-3 parts by weight of anti-bacterial agent in powder form; 0.2-0.8 parts by weight of a first hardener nanoparticle; 0.2-0.8 parts by weight of a second hardener nanoparticle; 0.2-0.8 parts by weight of defoamer; 0.2-0.8 parts by weight of wetting agent; 0.2-0.8 parts by weight of dispersing agent; and 5-15 parts by weight of water.

In a preferred embodiment using a liquid anti-bacterial agent, the coating comprises: 100 parts by weight of emulsion; 1-1.5 parts by weight of cross linking agent; 1-1.5 parts by weight of film forming agent; 3-5 parts by weight of anti-dust agent; 3-5 parts by weight of anti-bacterial agent in liquid form; 0.2-0.8 parts by weight of a first hardener nanoparticle; 0.2-0.8 parts by weight of a second hardener nanoparticle; 0.2-0.8 parts by weight of defoamer; and 5-15 parts by weight of water.

In another aspect of the invention, a method for fabricating the coating composition as mentioned above is disclosed. In one embodiment, the method comprises the steps of: mixing emulsion and anti-bacterial agent and anti-dust agent at room temperature for 20-45 minutes at 1000-2000 rpm; adding first hardener nanoparticle, second hardener nanoparticle and a first part of water and mix at room temperature for 20-45 minutes at 1000-2000 rpm; adding dispersion agent and wetting agent and mix at room temperature for 5-15 minutes at 500-1000 rpm; adding cross linking agent, film forming agent and a second part of water and mix at room temperature for 5-15 minutes at 200-800 rpm; and adding defoamer and mix at room temperature for 5-15 minutes at 200-800 rpm to obtain the coating mixture.

The anti-bacterial and anti-dust coating of the present invention can be applied on the inner surface of air ducting to reduce dust aggregation and prevent growth of bacteria, mold and mildew that causes stains and odors inside air ducting. The coating can be applied on the galvanized iron or metal surfaces directly by spraying or rolling.

### DETAILED DESCRIPTION OF INVENTION

A first embodiment of an anti-bacterial and anti-dust coating comprises: 100 parts by weight of a waterborne polymer emulsion to form a coating; 0.1-10 parts by weight of a cross linking agent to enhance water resistance property; 0.1-10 parts by weight of a film forming agent to form a smooth coating surface; 0.1-10 parts by weight of an anti-dust agent for anti-dust property; 0.1-10 parts by weight of an anti-bacterial agent for anti-bacterial property; 0.1-10 parts by weight of nanoparticles to enhance hardness; 0.1-10 parts by weight of a defoamer to reduce formation of foam and improve dense property of coating; and 1-15 parts by weight of water to adjust the viscosity and spraying of the coating.

The composition can be further divided into two formulas, where Formula A uses a powdery anti-bacterial agent and Formula B uses a liquid anti-bacterial agent. A wetting agent and a dispersing agent are needed for dispersing the powdery anti-bacterial agent in Formula A.

In a preferred embodiment of Formula A, the coating comprises: 100 parts by weight of emulsion; 1-1.5 parts by weight of cross linking agent; 1-1.5 parts by weight of film forming agent; 1.5-3 parts by weight of anti-dust agent; 1.5-3 parts by weight of anti-bacterial agent in powder form; 0.2-0.8 parts by weight of a first hardener nanoparticle; 0.2-0.8 parts by weight of a second hardener nanoparticle; 0.2-0.8 parts by weight of defoamer; 0.2-0.8 parts by weight of wetting agent; 0.2-0.8 parts by weight of dispersing agent; and 5-15 parts by weight of water.

In a specific exemplary embodiment of Formula A, the coating comprises: 100 parts by weight of emulsion; 1.44 parts by weight of cross linking agent; 1 part by weight of film forming agent; 3 parts by weight of anti-dust agent; 3 parts by weight of anti-bacterial agent in powder form; 0.5 parts by weight of a first hardener nanoparticle; 0.5 parts by weight of a second hardener nanoparticle; 0.25 parts by weight of defoamer; 0.25 parts by weight of a wetting agent; 0.5 parts by weight of a dispersion agent; and 8.67 parts by weight of water.

In a preferred embodiment of Formula B, the coating comprises: 100 parts by weight of emulsion; 1-1.5 parts by weight of cross linking agent; 1-1.5 parts by weight of film forming agent; 3-5 parts by weight of anti-dust agent; 3-5 parts by weight of anti-bacterial agent in liquid form; 0.2-0.8 parts by weight of a first hardener nanoparticle; 0.2-0.8 parts by weight of a second hardener nanoparticle; 0.2-0.8 parts by weight of defoamer; and 5-15 parts by weight of water.

In a specific exemplary embodiment of Formula B, the coating comprises: 100 parts by weight of emulsion; 1.44 parts by weight of cross linking agent; 1 part by weight of film forming agent; 3 parts by weight of anti-dust agent; 4 parts by weight of anti-bacterial agent in liquid form; 0.5 parts by weight of a first hardener nanoparticle; 0.5 parts by weight of a second hardener nanoparticle; 0.5 parts by weight of defoamer; and 6.67 parts by weight of water.

The coating can be applied on the galvanized steel or metal surfaces directly by spraying or rolling.

In various embodiments, the waterborne polymer emulsion comprises a styrene-acrylate copolymer emulsion, a styrene-butadiene copolymer emulsion, an acrylic emulsion, alkyd emulsion or a polyvinyl acetate emulsion. In an exemplary embodiment, the emulsion is a styrene-acrylic polymer emulsion (BATF-3212).

In various embodiments, the cross linking agent comprises a aziridine compound-type agent, a silane-type agent, a carbodiimide-type agent or a methylated melamine-type agent.

In various embodiments, the film forming agent comprises polyvinylpyrrolidone, 2,2,4-trimethyl-1,3pentanediol monoisobutyrate, hydrogenated polyisobutene, or copolymers.

In various embodiments, the anti-dust agent comprises an anti-static agent for dust free function, said anti-static agent comprises aliphatic amines, titanium dioxide, carbon black, or other conductive agents.

In various embodiments, the anti-bacterial agent comprises nano-silver dispersion, silver nanoparticle powder, zinc oxide nanoparticle powder, nano-zinc oxide dispersion or other anti-bacterial additives.

In various embodiments, the hardener nanoparticle comprises nano-silica, nano-aluminum oxide, nano-zinc oxide, nano-magnesium hydroxide or nano-calcium carbonate, a particle size of said nanoparticle is between 5 nm and 80 nm. In an exemplary embodiment, the first hardener nanoparticle is magnesium hydroxide with particle size of 200˜300 μm and the second hardener nanoparticle is aluminum oxide nanoparticle with particle size of 20˜40 nm.

In various embodiments, the defoamer comprises siloxane defoamer, polysiloxane defoamer or liquid molecular defoamer.

Various test are performed on the coating compositions, and test results are provided below.

Anti-Bacteria Test

Anti-bacteria test or anti-microbial test (JISZ 2801: 2012) is carried out for both Formula A and Formula B. Number of bacteria on a coated surface after 24 hours of inoculation is compared with an untreated control sample after 24 hours of incubation. Tables 1-4 below show the anti-bacterial results of Formula A and B on Staphylcoccus aureus and Escherichia coli respectively.

TABLE 1
Anti-bacterial test results of Formula A on Staphylcoccus aureus

| | | Log |
|---|---|---|
| Number of inoculated bacteria in Untreated Control | 2.30 × 10⁵ | 5.4 |
| Sample (A) | | |
| Number of bacteria in Untreated Control Sample | 3.89 × 10⁶ | 6.6 |
| after 24 hours of incubation (B) | | |
| Number of bacteria in Treated Sample (C) | 10 | 1.0 |

TABLE 2
Anti-bacterial test results of Formula A on Escherichia coli

| | | Log |
|---|---|---|
| Number of inoculated bacteria in Untreated Control | 3.79 × 10⁵ | 5.6 |
| Sample (A) | | |
| Number of bacteria in Untreated Control Sample | 3.89 × 10⁶ | 6.6 |
| after 24 hours of incubation (B) | | |
| Number of bacteria in Treated Sample (C) | 10 | 1.0 |

TABLE 3
Anti-bacterial test results of Formula B on Staphylcoccus aureus

| | | Log |
|---|---|---|
| Number of inoculated bacteria in Untreated Control | 2.30 × 10⁵ | 5.4 |
| Sample (A) | | |
| Number of bacteria in Untreated Control Sample | 3.89 × 10⁶ | 6.6 |
| after 24 hours of incubation (B) | | |
| Number of bacteria in Treated Sample (C) | 10 | 1.0 |

TABLE 4
Anti-bacterial test results of Formula B on Escherichia coli

| | | Log |
|---|---|---|
| Number of inoculated bacteria in Untreated Control | 3.79 × 10⁵ | 5.6 |
| Sample (A) | | |
| Number of bacteria in Untreated Control Sample | 3.89 × 10⁶ | 6.6 |
| after 24 hours of incubation (B) | | |
| Number of bacteria in Treated Sample (C) | 10 | 1.0 |

Anti-bacterial Activity value of Sample is calculated by Log B−Log C, and is judged as effective when the values are greater than 2.0. Tables 1-4 show that the Anti-bacterial Activity value of both formulas in both kinds of bacteria are 5.6, meaning the coating of the present invention possesses anti-bacterial capability.

Anti-Acid and Anti-Alkali Test

The coating of the present invention is tested for acid and alkali resistance. The coating is applied on iron or ZAM substrate with a uniform thickness around 60 microns. The coating is then cured for 7 days and any initial morphology is recorded. Afterwards, 5% w/w hydrogen sulphate solution (pH ˜1.37) or 5% w/w sodium hydroxide solution (pH-13.4) is placed randomly on the coated surface for 24 hours (ASTM D1308). The acid or alkali liquid spots are then cleaned and examined for effects including bubbles, blister or cracking. Test results on both Formula A and Formula B shows no blisters or loss of adhesion phenomenon for the coating on metal substrates.

On bending resistance, the coating cannot be picked off after 180° bend (1T bend) of the coated metal to ASTM D4145 standard.

On hardness of the coating, the hardness is at least 2H or above to ASTM D 3363 standard.

Anti-Dust Test

The anti-dust performances of the coating is evaluated by testing of surface resistance with reference to ASTM F150. A coating is spray-applied on galvanized iron and ZAM substrates, and then placed on a Teflon plate. Surface resistivity (Rₛ) is then read by an auto ranging digital resistance meter. Materials with surface resistivity of 1×10⁶˜1×10¹⁰ Ω/sq are regarded as anti-static material.

TABLE 5
Surface resistivity of substrates coated with coating compositions

| | |
|---|---|
| Formula A, GI substrate | 2.75 × 10⁹ |
| Formula B, GI substrate | 2.84 × 10⁹ |
| Formula A, ZAM substrate | 2.13 × 10⁹ |
| Formula B, ZAM substrate | 2.26 × 10⁹ |

An alternative test is conducted for testing dust repellency of the coating. The initial weight of the coated specimen is first recorded. A certain amount of graphite powder is spilled evenly onto the coated surface to simulate ash contamination. After 5 minutes, graphite powder on the sample surface is removed under a simulated certain wind velocity (e.g. 2˜2.5 m/s). The final weight of the specimen is then recorded and normalized to the initial weight. Test results show that the normalized weight change is 29 ppm for Formula A and 42 ppm for Formula B, comparing to 2065 ppm for uncoated specimen.

Anti-Bending Test

Coated specimens are bent for 180° around and morphology of coatings are inspected via optical microscopy at low magnification (5 to 10×) by means of a 3M tape pull-off test based on ASTM D4145. No cracking or breakage was found on the bending area of the specimens for both Formula A and Formula B.

Fire Test, Volatile Organic Substance (VOC) Test and Hazardous Substance Test

Spread of flame test on coated sample shows compliance to Class 1 of BS476: Part 7: 1997. This indicates the coating is fire resistant and does not help flame spread in cases of fire. VOC test shows a VOC of 19.6 grams per liter of coating composition in a maximum permissible limit of 500. Hazardous substance test with reference to IEC 62321-4:2013+AMD1:2017, IEC62321-5:2013, IEC62321-7-2:2017, IEC62321-6:2015 shows no hazardous substance is found in the coating composition.

In another aspect of the invention, a method for fabricating the coating composition as mentioned above is disclosed. The method comprises the steps of: adding anti-bacterial agent and anti-static agent into waterborne polymer emulsion under mechanical agitation; dispersing hardness agent nanoparticle into water under ultrasonic process or powerful mixer to obtain a dispersed nanoparticle solution; putting the dispersed nanoparticle solution into a polymer matrix under mechanical agitation to obtain a homogenous liquid emulsion; adding cross-linking agent and film forming agent to the homogenous liquid emulsion under continuous stirring; and adding the deformer agent to said homogenous liquid emulsion under continuous stirring to obtain the coating composition.

In a preferred embodiment of manufacturing of Formula A, the method comprises the steps of: mixing emulsion and powder anti-bacterial agent and anti-dust agent at room temperature for 20-45 minutes at 1000-2000 rpm; adding first hardener nanoparticle, second hardener nanoparticle and a first part of water and mix at room temperature for 20-45 minutes at 1000-2000 rpm; adding dispersion agent and wetting agent and mix at room temperature for 5-15 minutes at 500-1000 rpm; adding cross linking agent, film forming agent and a second part of water and mix at room temperature for 5-15 minutes at 200-800 rpm; and adding defoamer and mix at room temperature for 5-15 minutes at 200-800 rpm to obtain the coating mixture.

In one specific embodiment of manufacturing of Formula A, the method comprises the steps of: adding 300 g of powder anti-bacterial agent and 300 g of anti-dust agent (titanium oxide) into 10 kg of the waterborne polymer emulsion and mixing at room temperature for 40 minutes at 1700 rpm, so as to disperse the powder anti-bacterial agent and titanium oxide into the emulsion polymer matrix; adding 50 g of first hardener nanoparticle (magnesium hydroxide), 50 g of second hardener nanoparticle (aluminum oxide) and 500 g of water into the mixture and mixing at room temperature for 30 minutes at 1700 rpm; adding 25 g of wetting agent and 50 g of dispersion agent to the mixture and mixing at room temperature for 5 minutes at 500 rpm; adding 144 g of cross-linking agent, 100 g of film forming agent and 367 g of water to the mixture and mixing at room temperature for 10 minutes at 300 rpm; adding 25 g defoamer to the mixture and mixing at room temperature for 10 minutes at 200 rpm to obtain the coating mixture.

In a preferred embodiment of manufacturing of Formula B, the method comprises the steps of: mixing emulsion and liquid anti-bacterial agent and anti-dust agent at room temperature for 20-45 minutes at 1000-2000 rpm; adding first hardener nanoparticle, second hardener nanoparticle and a first part of water and mix at room temperature for 20-45 minutes at 1000-2000 rpm; adding cross linking agent, film forming agent and a second part of water and mix at room temperature for 5-15 minutes at 200-800 rpm; and adding defoamer and mix at room temperature for 5-15 minutes at 200-800 rpm to obtain the coating mixture.

In a specific embodiment of manufacturing of Formula B, the method comprises the steps of: adding 400 g of liquid anti-bacterial agent and 300 g of anti-dust agent (titanium oxide) into 10 kg of the waterborne polymer emulsion and mixing at room temperature for 40 minutes at 1700 rpm, so as to disperse the liquid anti-bacterial agent and titanium oxide into the emulsion polymer matrix; adding 50 g of first hardener nanoparticle (magnesium hydroxide), 50 g of second hardener nanoparticle (aluminum oxide) and 500 g of water into the mixture and mixing at room temperature for 30 minutes at 1700 rpm; adding 144 g of cross-linking agent, 100 g of film forming agent and 167 g of water to the mixture and mixing at room temperature for 10 minutes at 300 rpm; adding 50 g defoamer to the mixture and mixing at room temperature for 10 minutes at 200 rpm to obtain the coating composition.

Experimental results show that stirring speed and other processing conditions of mixers should be adjusted to achieve homogenous dispersion of additives and successful reaction for obtaining the anti-bacterial and anti-dust coating.

The preferred embodiments of the present invention are hereby disclosed. The preferred embodiments only explain the present invention by way of example, but not limitation. It is obvious that a person skilled in the art can make various modifications and adjustments to the details without departing from the spirit and concept of the present invention. The scope of the present invention is not limited to the specification but is defined by the scope of the claims.

What is claimed is:

1. A coating composition, comprising:
100 parts by weight of a waterborne polymer emulsion to form a coating;
0.1-10 parts by weight of a cross linking agent to enhance water resistance property;
0.1-10 parts by weight of a film forming agent to form a smooth coating surface;
0.1-10 parts by weight of an anti-dust agent for anti-dust property;
0.1-10 parts by weight of an anti-bacterial agent for anti-bacterial property;
0.1-10 parts by weight of hardener nanoparticles to enhance hardness;
0.1-10 parts by weight of a defoamer to reduce formation of foam and improve dense property of coating; and
1-15 parts by weight of water to adjust the viscosity and spraying of the coating.

2. The coating composition of claim 1, wherein said composition comprises:
100 parts by weight of said waterborne polymer emulsion;
1-1.5 parts by weight of said cross linking agent;
1-1.5 parts by weight of said film forming agent;
1.5-3 parts by weight of said anti-dust agent;
1.5-3 parts by weight of said anti-bacterial agent; said anti-bacterial agent is in powder form;
0.2-0.8 parts by weight of a first hardener nanoparticle;
0.2-0.8 parts by weight of a second hardener nanoparticle;
0.2-0.8 parts by weight of said defoamer;
0.2-0.8 parts by weight of a wetting agent;
0.2-0.8 parts by weight of a dispersing agent; and
5-15 parts by weight of said water.

3. The coating composition of claim 2, wherein said composition comprises:
100 parts by weight of said waterborne polymer emulsion;
1.44 parts by weight of said cross linking agent;
1 part by weight of said film forming agent;
3 parts by weight of said anti-dust agent;
3 parts by weight of said anti-bacterial agent; said anti-bacterial agent is in powder form;
0.5 parts by weight of said first hardener nanoparticle;
0.5 parts by weight of said second hardener nanoparticle;
0.25 parts by weight of said defoamer;
0.25 parts by weight of a wetting agent;
0.5 parts by weight of a dispersing agent; and
8.67 parts by weight of said water.

4. The coating composition of claim 1, wherein said composition comprises:
100 parts by weight of said waterborne polymer emulsion;
1-1.5 parts by weight of said cross linking agent;
1-1.5 parts by weight of said film forming agent;
3-5 parts by weight of said anti-dust agent;
3-5 parts by weight of said anti-bacterial agent; said anti-bacterial agent is in liquid form;
0.2-0.8 parts by weight of a first hardener nanoparticle;
0.2-0.8 parts by weight of a second hardener nanoparticle;
0.2-0.8 parts by weight of said defoamer; and
5-15 parts by weight of said water.

5. The coating composition of claim 4, wherein said composition comprises:
100 parts by weight of said waterborne polymer emulsion;
1.44 parts by weight of said cross linking agent;
1 part by weight of said film forming agent;
3 parts by weight of said anti-dust agent;
4 parts by weight of said anti-bacterial agent; said anti-bacterial agent is in liquid form;
0.5 parts by weight of said first hardener nanoparticle;
0.5 parts by weight of said second hardener nanoparticle;
0.5 parts by weight of said defoamer; and
6.67 parts by weight of said water.

6. The coating composition of claim 1, wherein said waterborne polymer emulsion comprises a styrene-acrylate copolymer emulsion, a styrene-butadiene copolymer emulsion, an acrylic emulsion, alkyd emulsion or a polyvinyl acetate emulsion.

7. The coating composition of claim 1, wherein said cross linking agent comprises a aziridine compound-type agent, a silane-type agent, a carbodiimide-type agent or a methylated melamine-type agent.

8. The coating composition of claim 1, wherein said film forming agent comprises polyvinylpyrrolidone, 2,2,4-trimethyl-1,3pentanediol monoisobutyrate, hydrogenated polyisobutene, or copolymers.

9. The coating composition of claim 1, wherein said anti-dust agent comprises an anti-static agent for dust free function, said anti-static agent comprises aliphatic amines, titanium dioxide, carbon black, or other conductive agents.

10. The coating composition of claim 1, wherein said anti-bacterial agent comprises nano-silver dispersion, silver nanoparticle powder, zinc oxide nanoparticle powder, nano-zinc oxide dispersion or other anti-bacterial additives.

11. The coating composition of claim 1, wherein said hardener nanoparticle comprises nano-silica, nano-aluminum oxide, nano-zinc oxide, nano-magnesium hydroxide or nano-calcium carbonate, a particle size of said nanoparticle is between 5 nm and 80 nm.

12. The coating composition of claim 11, wherein said hardener nanoparticle comprises a first hardener nanoparticle and a second hardener nanoparticle, said first hardener nanoparticle being magnesium hydroxide with particle size of 200˜300 μm and said second hardener nanoparticle being aluminum oxide nanoparticle with particle size of 20˜40 nm.

13. The coating composition of claim 1, wherein said defoamer comprises siloxane defoamer, polysiloxane defoamer or liquid molecular defoamer.

14. A method for manufacturing said coating composition of claim 1, comprising the steps of:
mixing said anti-bacterial agent, said anti-dust agent and said waterborne polymer emulsion and mixing at room temperature for 20-45 minutes at 1000-2000 rpm;
adding said hardener nanoparticles and a first part of said water into said mixture and mixing at room temperature for 20-45 minutes at 1000-2000 rpm;
adding said cross-linking agent, said film forming agent and a second part of said water to said mixture and mixing at room temperature for 5-15 minutes at 200-800 rpm; and
adding said defoamer to said mixture and mixing at room temperature for 5-15 minutes at 200-800 rpm to obtain said coating composition.

15. The method of claim 14, wherein said anti-bacterial agent is a powder anti-bacterial agent, the method further comprising the steps of:
after adding said hardener nanoparticles into said mixture, adding a dispersion agent and a wetting agent to said mixture and mixing at room temperature for 5-15 minutes at 500-1000 rpm.

16. The method of claim 14, comprising the steps of:
mixing said anti-bacterial agent, said anti-dust agent and said waterborne polymer emulsion and mixing at room temperature for 40 minutes at 1700 rpm;
adding said hardener nanoparticles and a first part of said water into said mixture and mixing at room temperature for 30 minutes at 1700 rpm;
adding said cross-linking agent, said film forming agent and a second part of said water to said mixture and mixing at room temperature for 10 minutes at 300 rpm; and
adding said defoamer to said mixture and mixing at room temperature for 10 minutes at 200 rpm to obtain said coating composition.

17. A method of coating an internal surface of an air duct comprising the step of applying said coating composition of claim 1.
